(19) United States
(12) Patent Application Publication
(10) Pub. No.: US 2006/0002614 A1
(43) Pub. Date: Jan. 5, 2006

(54) Raster-to-vector conversion process and apparatus

(75) Inventor: Guy LeHenaff, Paris (FR)

Correspondence Address: MERCHANT & GOULD PC, P.O. BOX 2903, MINNEAPOLIS, MN, 55402-0903, US

(73) Assignee: ALLIANCES ARTQUEST INTERNATIONAL INC., Laval (CA)

(21) Appl. No.: 10/881,485

(22) Filed: Jun. 30, 2004

(51) Int. Cl. G06K 9/36

(52) U.S. Cl. 382/242; 382/245

(57) ABSTRACT

A raster-to-vector conversion process for converting a pattern descriptive coded image into a vector coded image. A progress marking plane with structural elements determined as a function of pattern data in the image is created in pattern descriptive format. The progress marking plane is pre-loaded with index data stored in the structural elements and indicative of an aspect similarity between image-forming units in the image. Object contours in the image are searched as a function of an aspect correlation between the image-forming units as determined from the index data. The faces of the image-forming units explored while searching are marked in associated ones of the structural elements of the progress marking plane, to prevent a face forming a part of an object contour found while searching from being considered again. Vector data representative of the faces of image-forming units defining the object contours found while searching are generated and the vector image is produced by assembling the vector data.

### FIELD OF THE INVENTION

The present invention relates to image processing, and more particularly to raster-to-vector conversion process and apparatus.

### BACKGROUND

In the image processing art such as applied in the printing industry, raster descriptions are more safe for preserving image fidelity whereas vector descriptions are more flexible e.g. for image manipulations. The possibly best compromise may be to start with a raster description of an image and then to provide a vector description of the image using a contour tracking or edge detection process. However, opting for this strategy involves to deal with two rather incompatible constraints. A good quality of contour tracking requires a very high raster resolution e.g. 2400 dpi. A good product must be fast and require little resources to be efficient. However, a raster description can be efficient only when it is compressed due to the necessary amount of memory for storing it. The vectorization process involves a contour tracking which requires a random access in the image matrix. Compressed descriptions of images poorly go with random access. The first reflex is then to decompress the image data for achieving the contour tracking, but this is incompatible with the speed and performance goals.

U.S. Pat. Nos. 4,149,165 (Herman et al.), 4,500,919 (Schreiber), 4,698,688 (Ochi et al.), 4,722,064 (Suzuki), 4,918,624 (Moore et al.), 4,928,243 (Hodges et al.), 4,975,858 (Ikenoue et al.), 5,113,249 (Yosefi), 5,131,058 (Ting et al.), 5,146,346 (Knoll), 5,150,453 (Hala et al.), 5,150,455 (Morikawa et al.), 5,258,854 (Eschbach), 5,264,942 (Shimotsuji et al.), 5,293,539 (Spence), 5,296,935 (Bresler), 5,305,111 (Chao et al.), 5,327,527 (Hatayama), 5,337,319 (Furukawa et al.), 5,359,673 (de La Beaujardiere), 5,483,351 (Mailloux et al.), 5,642,476 (Turner), 5,680,485 (Loce et al.), 5,696,842 (Shirasawa et al.), 5,752,057 (Lifshitz et al.), 5,812,695 (Dawe), 5,901,245 (Warnick et al.), 5,940,540 (Cornelissen), 6,055,064 (Lifshitz et al.), 6,115,140 (Bresler et al.), 6,198,508 (Jang et al.), 6,226,400 (Doll), 6,324,300 (Doll), 6,393,146 (Doll), 6,396,947 (Doll), 6,614,932 (Iwane), 6,728,392 (Joshi), 6,728,399 (Doll), European patent EP 0 557 008 (Bieber et al.) and U.S. published patent applications 2002/0064307 (Koga et al.), 2002/0106135 (Iwane), 2002/0154134 (Matsui) show examples of image processing methods and apparatus.

### SUMMARY

An object of the invention is to provide a raster-to-vector conversion process for converting a pattern descriptive coded image into a vector coded image without decompression of the pattern descriptive coded image.

Another object of the invention is to provide a raster-to-vector conversion process which is achievable using a small amount of memory.

Another object of the invention is to provide a raster-to-vector conversion process which can respect all the details of the original raster image, without resolution changes.

According to one aspect of the present invention, there is provided a raster-to-vector conversion process for converting a pattern descriptive coded image into a vector coded image, comprising:
creating a progress marking plane in pattern descriptive format with structural elements determined as a function of pattern data in the pattern descriptive coded image;
pre-loading the progress marking plane with index data stored in the structural elements, the index data being indicative of an aspect similarity between image-forming units in the pattern descriptive coded image;
searching adjacent faces of image-forming units in the pattern descriptive coded image defining object contours as a function of an aspect correlation between the adjacent faces as determined from the index data stored in the progress marking plane;
marking the faces of the image-forming units explored while searching in associated ones of the structural elements of the progress marking plane, to prevent a face forming a part of an object contour found while searching from being considered again;
generating vector data representative of the faces of image-forming units defining the object contours found while searching; and
producing the vector image by assembling the vector data.

According to another aspect of the present invention, there is also provided a raster-to-vector conversion apparatus for converting a pattern descriptive coded image into a vector coded image, comprising:
means for creating a progress marking plane in pattern descriptive format with structural elements determined as a function of pattern data in the pattern descriptive coded image;
means for pre-loading the progress marking plane with index data stored in the structural elements, the index data being indicative of an aspect similarity between image-forming units in the pattern descriptive coded image;
means for searching adjacent faces of image-forming units in the pattern descriptive coded image defining object contours as a function of an aspect correlation between the adjacent faces as determined from the index data stored in the progress marking plane;
means for marking the faces of the image-forming units explored while searching in associated ones of the structural elements of the progress marking plane, to prevent a face forming a part of an object contour found while searching from being considered again;
means for generating vector data representative of the faces of image-forming units defining the object contours found while searching; and
means for producing the vector image by assembling the vector data.

According to another aspect of the present invention, there is also provided a computer readable memory having recorded thereon statements and instructions for execution by a computer to carry out the above process.

According to another aspect of the present invention, there is also provided a computer program product, comprising a memory having computer readable code embodied therein, for execution by a processor, for converting a pattern descriptive coded image into a vector coded image, said code comprising:
code means for creating a progress marking plane in pattern descriptive format with structural elements determined as a function of pattern data in the pattern descriptive coded image;
code means for pre-loading the progress marking plane with index data stored in the structural elements, the index data being indicative of an aspect similarity between image-forming units in the pattern descriptive coded image;
code means for searching adjacent faces of image-forming units in the pattern descriptive coded image defining object contours as a function of an aspect correlation between the adjacent faces as determined from the index data stored in the progress marking plane;
code means for marking the faces of the image-forming units explored while searching in associated ones of the structural elements of the progress marking plane, to prevent a face forming a part of an object contour found while searching from being considered again;
code means for generating vector data representative of the faces of image-forming units defining the object contours found while searching; and
code means for producing the vector image by assembling the vector data.

According to another aspect of the present invention, there is also provided a carrier wave embodying a computer data signal representing sequences of statements and instructions which, when executed by a processor, cause the processor to convert a pattern descriptive coded image into a vector coded image, the statements and instructions comprising:
creating a progress marking plane in pattern descriptive format with structural elements determined as a function of pattern data in the pattern descriptive coded image;
pre-loading the progress marking plane with index data stored in the structural elements, the index data being indicative of an aspect similarity between image-forming units in the pattern descriptive coded image;
searching adjacent faces of image-forming units in the pattern descriptive coded image defining object contours as a function of aspect correlation between the adjacent faces as determined from the index data stored in the progress marking plane;
marking the faces of the image-forming units explored while searching in associated ones of the structural elements of the progress marking plane, to prevent a face forming a part of an object contour found while searching from being considered again;
generating vector data representative of the faces of image-forming units defining the object contours found while searching; and
producing the vector image by assembling the vector data.

According to another aspect of the present invention, there is also provided a memory for storing data for access by an application program being executed on a data processing system, comprising a data structure stored in said memory, said data structure including information resident in a database in pattern descriptive format used by said application program and including structural element data stored in said memory representing structural elements created as a function of pattern data in a pattern descriptive coded image to be converted into a vector coded image and usable to store index data indicative of an aspect similarity between image-forming units in the pattern descriptive coded image and marking data indicative of image-forming units explored during conversion of the pattern descriptive coded image into a vector coded image.

According to another aspect of the present invention, there is also provided a memory for storing data for access by an application program being executed on a data processing system, comprising a data structure stored in said memory, said data structure including information resident in a database in pattern descriptive format used by said application program and including pointers indicating positions of a number of patterns spaced apart in a pattern descriptive coded image to be converted into a vector coded image and usable for accelerated navigation in the pattern descriptive coded image when searching object contours in the pattern descriptive coded image based on image-forming unit coordinates.

### BRIEF DESCRIPTION OF THE DRAWINGS

A detailed description of preferred embodiments will be given herein below with reference to the following drawings, in which like numbers refer to like elements:

FIG. 1 is a schematic diagram illustrating a raster image with pixels stored in Cartesian coordinates without compression.

FIG. 2 is a schematic diagram illustrating a run-length coded image.

FIG. 3 is a schematic diagram illustrating layers forming an image in Tagged Image File Format/Image Technology (TIFF/IT).

FIG. 4 is a schematic diagram illustrating the principles of contour tracking.

FIG. 5 is a schematic diagram illustrating an example of a progress marking plane before contour tracking.

FIG. 6 is a schematic diagram illustrating a run-length contour tracking.

FIG. 7 is a flowchart illustrating the raster-to-vector conversion process.

FIG. 8 is a schematic block diagram illustrating a raster-to-vector apparatus.

### DETAILED DESCRIPTION OF THE PREFERRED EMBODIMENTS

As used in connection with this disclosure, the expression “pattern descriptive” represents a category of coding or format referring to any compression using a pattern which can be encoded using a description of a pattern and a repetition factor. Single dimension coding falling in the pattern descriptive category includes, for example, run-length, PackBits, Huffman coding as in CCITT (Consultative Committee for International Telegraph and Telephone) G3 and G4 coding. In the run-length format, the pattern is a color transition within a line and the repetition factor is the number of pixels with the same color. The coding may be absolute (distance from origin) or relative (distance from previous pattern) and may include delta encoding or compression scheme. G3 and G4 compressions use known contour tables and G4 even codes the difference with the next line, which is a very valuable data when practicing the disclosed process. In the PackBits format, the description contains a flag to encode the data. The repetition factor may be a number of pixels of defined color or a pixel span width or height. In the Huffman coding, the pattern is a Huffman table and the repetition factor is the pattern repetition. Multiple dimension coding falling in the pattern descriptive category includes, for example, tiling based coding including fractal compression where the pattern is contained in a tile and the repetition factor includes a coordinate position as well as a relative position to the previous tile. The tile may be non-rectangular.

The run-length format has been chosen in this disclosure to describe embodiments of the invention for illustrative purposes only. It should be understood that any other format, as listed above or in addition thereto, falling in the aforesaid pattern descriptive category is contemplated.

Very high resolution images, reversibly compressed, often use compressions based on coding of the redundancies in the image. This coding is often considered as a constraint during the image processing since it is often necessary to decompress the image data for using them. But in certain cases, for example in the graphic arts, the decompressed data exceed the maximum memory capacity of the existing classical computers and represent huge files on the disk (many tens of Gb). The disclosed process advantageously process the data directly in their compressed format. It even accelerates the process since the compression processes are capable of directly providing certain coordinates without requiring complementary computations.

The disclosed raster-to-vector conversion process is for converting various raster file formats (e.g. Tiff) into vector information (e.g. PDF, PS), as especially useful for the printing industry and other applications. The process carries out an analysis of object contours in an image and vectorizes them using a procedure especially developed for this purpose. All the details of the original raster image are respected, without resolution changes.

The process is related to a pattern descriptive type decoding mode in which the compression is achieved by coding the type of information and the repetition count of the information, for example the color, and the distance covered by the color. The compression rates in use for this type of coding are excellent in the case of very high resolution pages (2400 dpi) and easily reach 500:1.

A typical raster contour conversion towards a vector format carries out a contour tracking by examining, at each pixel, the surrounding pixels until finding a solution of continuity of the chosen contour. To avoid considering falsely a contour at an ulterior stage of the process, it is necessary to mark each pixel in a special plane to prevent it from being considered again afterwards. The special plane is as large as the image plane, and will even contain between 4 to 8 times more necessary information since a pixel has 4 surrounding pixels by the faces and 4 surrounding pixels by the diagonals. Not only the size of the necessary raster plane may be prohibitive, but the detection is not very effective if the data are frequently repeated, which is often the case. And even if a random searching process in sequentially arranged data (e.g. a compressed data image) is provided, it is still necessary to create a marking plane.

The disclosed raster-to-vector conversion process consists, in short, to preprocess the compressed image file for building directly the base of a progress marking plane. Indeed, it is predictable that each pixel will have a neighbor. It is then possible to create in advance supplementary data around the pixel to provide the contour coding process with an appropriate space where the contour tracking information may be stored. During this pre-coding operation (analogous to a pre-convolution), it is also possible to directly determine the color correlation of certain pixels between them to direct the following coding to accelerate it (typically, examination of the colors of the pixels above and below, since the penalty for navigating in a compressed file is greater in the leading direction (e.g. Y direction across the lines) than in a line (e.g. X direction)).

During the contour tracking, it becomes then easy to mark the contour without involving computation time consuming processes for example for run-length segment insertion. The process is also advantageous in that it allows a maximal optimization following the coding direction. Indeed, instead of considering all the pixels on a line one by one, the pre-convolution has the effect of allowing creation of segments having a well defined length each corresponding to a minimal geographical feature requiring a re-examination of the situation by the contour tracking process. It then becomes possible to directly jump to the next interesting pixel in the line by means of a simple addition of the repetition coefficient to the current coordinates.

Referring to FIG. 1, there is shown a schematic diagram illustrating a raster image with pixels stored in classical Cartesian coordinates without compression. Usually, the image matrix is entirely loaded in memory, which provides the advantage that the storage and addressing is very simple. However, the size of the matrix is prohibitive for large images, e.g. over 10 000 pixels.

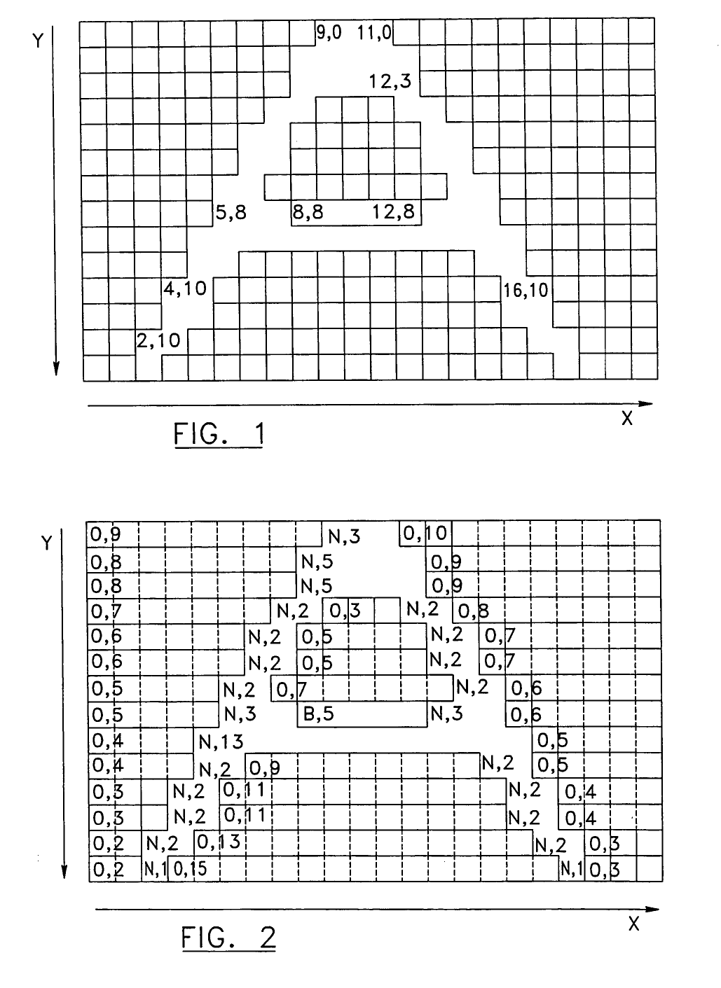

Referring to FIG. 2, there is shown a schematic diagram illustrating a run-length (RL) coded image. Pixels are a sequence of bytes representing a pair (length, color). Runs of identical pixel values (e.g. color) are compressed into a count and a value. As the compression is a sequential collection, determination of a position requires a reading of all the preceding bytes. The image size is advantageously small. However, the addressing is difficult. Changes are simple (change of the color or the index). The addition of data is virtually impossible as it is necessary to “open” the run of bytes and to insert new segments, which requires extremely frequent time consuming memory move.

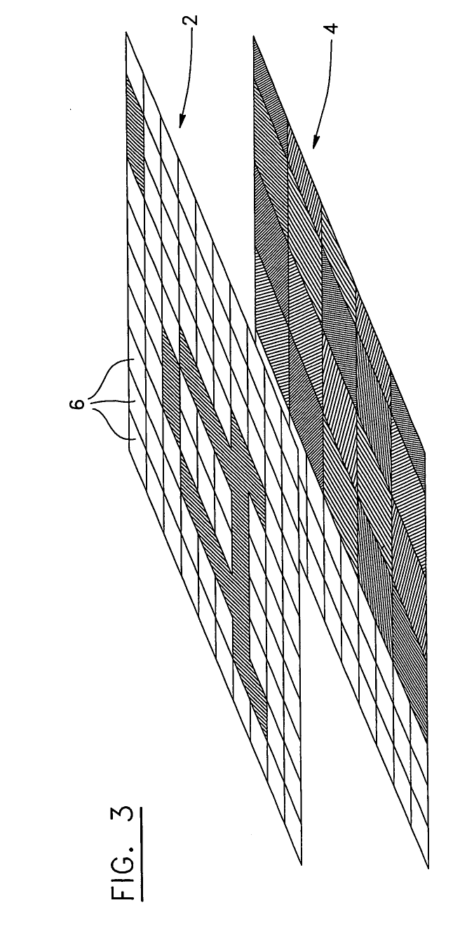

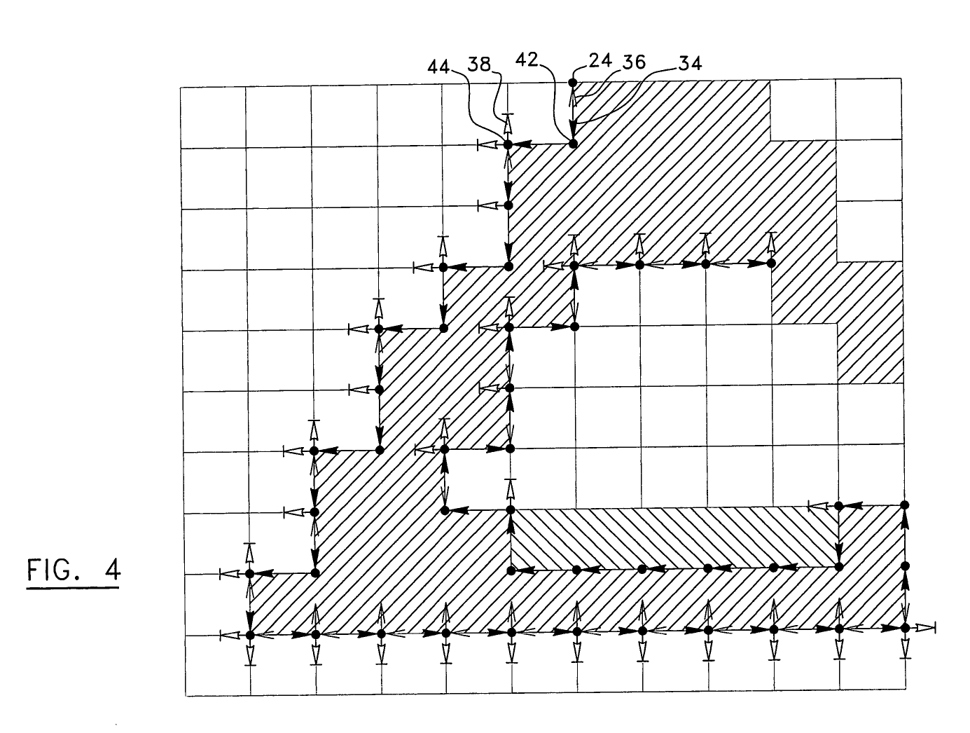

Referring to FIG. 3, there is shown a schematic diagram illustrating layers forming an image in Tagged Image File Format/Image Technology (TIFF/IT). TIFF/IT is an unscreened format. It is an add-on to the well known basic TIFF specifications, especially for the prepress industry. TIFF/IT is a standard for the exchange of digital adverts and complete pages. TIFF/IT is used for example for the exchange of adds for newspapers or magazines and the exchange of pages for magazine printers. TIFF/IT files may be made of a layered combination of artwork planes 2 (higher level), screened plane (intermediate level, if any—not shown in the Figure) and image plane 4 (lower level). The artwork plane may contain HC (High resolution Contone) or LW (LineWork) components. HC may be used for art works and high resolution images, with no color limits. LW may be used for art works with less than 256 colors. The screened plane may contain BL (Binary Linework) or BP (Binary Picture) components for uncompressed binary level, or SD (Super Density) Compressed CCITT (Consultative Committee for International Telegraph and Telephone) G3 or G4 components. The image plane may contain CT (Continuous Tone) for images in CMYK (Cyan Magenta Yellow Black) or MP (Monochrome Picture) components for black and white images or spot layers. Each pixel 6 in the planes is described by an 8 bit value, and the image data is run-length compressed. Any upper layer such as the artwork plane 2 or intermediate plane will overwrite the layer content of the image plane 4. Since the CT layer contains few particularities, it will generally not be subjected to a contour tracking. As a part of the document to be processed, it will simply be re-incorporated when generating the final vector format. RL is generally used for text and illustration sections. The LW and HC formats as shown in table I below are highly used in the graphic arts, e.g. on the basis of the ISO TIFF-IT 8.8 standard.

TABLE I
Line Work (LW)
Run Length in indexed color

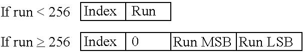

High resolution Contone (HC)
Run Length in direct CMYK color

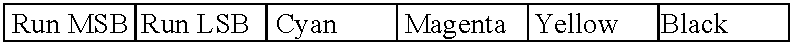

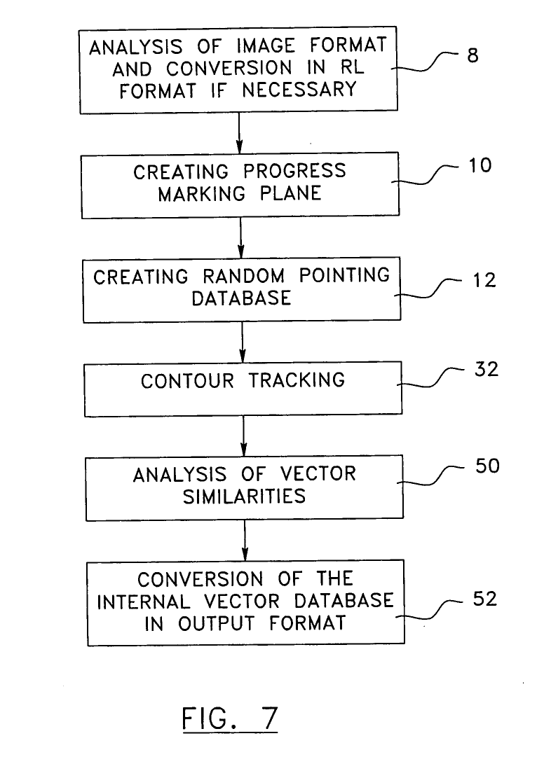

Referring to FIG. 7, the raster-to-vector conversion process comprises the following steps. As depicted by block 8, analysis of the input image format may be achieved so that various raster image formats may be processed, e.g. bitmaps. The image can then be converted in RL format if necessary. All the subsequent processing is directly made using the RL entries without decompression of the image data.

As depicted by block 10, a progress marking plane is created with segments determined as a function of run data in the run-length coded image, in view of the eventual contour tracking. This plane will be pre-loaded with vital data for direct image processing in RL format. To this effect, an analysis of the color similarities in the image over three lines at a time (above, current and below) and a similar analysis over three successive pixels in a line may be achieved. New run-length segments of unitary length are created in the progress marking plane before and after each existing color transition (border) in the image. The segments pre-loaded in the progress marking plane are thus formed of the new segments and segments derived from the run data reduced as a result of the new segments created. A value pre-marking the nature of the current pixel with respect to the neighbor (identical to the pixel on the left, on the right, above and below, i.e. indicative of color similarity between pixels in the image) is stored in the segments of the progress marking plane as index data. Thus, the marking plane is itself in RL format, and contains line and column color similarity information. The progress marking plane will be updated and referred to during the contour tracking phase. The interesting locations are the faces and the corners of the pixels. Each failure or success while performing the contour tracking will be reported in the progress marking plane.

The above analysis may involve three lines though it is not really done over three lines. It is necessary, for each border, to determine where to go (one line of difference with respect to the current line) and to mark from where the operation comes (the other line). The actions on each line (and also on each column, as the process is identical) are thus different. The simplest case is in a vertical or horizontal direction. The previous pixel will be informed that the current position has been covered so that an eventual repassage (case where two contours are touching each other) triggers a signal indicating that this location must not be searched again as it has already been done. The current pixel will be marked as covered, and the 3+1 logical directions from the locations of origin will be explored (no marking yet) to determine where to go. Also, in the three successive pixel analysis, it is rather the runs which are considered, but since it is the borders of the runs which are of interest, it is in fact a pixel in the geometrical plane which is considered, though it is the color of a run which is considered at the computer level.

The principle of the progress marking plane is that for marking data, a sufficient number of bits must be available for storing information regarding each pixel border. Each border involves three marking data, one before the border, one for the border pixel, and the other one after the border (and thus changing the length of the subsequent run). A single pixel, alone, lost in the middle of a document thus has eight pixels around it in the marking plane. Without knowing the content of a page, the marking plane can be prepared simply by adding a unitary run just before each existing run, by reducing the existing run by two to take into account supplementary run lengths, and by creating a run after the existing run. The marking plane is thus a run-length file of the same type as the input file, but larger since it will contain complementary runs for marking borders during the contour tracking. The huge advantage of such a marking plane is that once created, it is no longer necessary to add data during the contour tracking. Indeed, adding data to data already compressed in run-length consists in inserting new segments, which is very laborious in terms of quantity of data to be moved. With the present marking plane, enough data already exist so that an available bit can always be found for marking the passage by a contour. Depending upon the simplicity of the pre-computation, there may even be too many data but seldom and the penalty is low with respect to the run time gain.

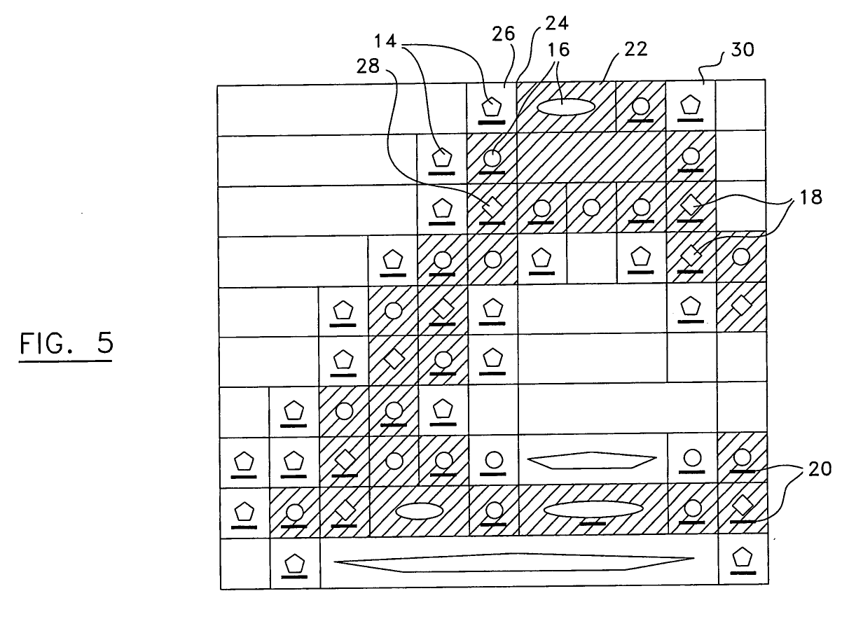

Referring to FIG. 5, there is shown an example of a progress marking plane before contour tracking for an upper portion of the image shown in FIGS. 1 and 2. The segments with diamond marks 14 will be useful for scrutiny purposes only. The segments with circle (or ellipse) marks 16 identify color segments. The segments with square marks 18 identify color similarity between the lines. The segments with line marks 20 have been created specifically for the marking plane. These segments derive from the intersection of the above and below segments. Their starting and ending points are unions of the starting and ending points of the run lengths immediately above and below. As the contour tracking requires to mark the locations covered, the marking of pixels is advantageously replaced by the marking of segments. There is a sufficiently tight relation between the original data and the marking plane to be sure to have at least enough data for marking all the angles (without falling on a marking plane which would be a matrix of pixels being much too large and exigent in manipulations). Segment 22 will be the starting segment of the first interesting pixel. The corner 24 of the external contour will trigger a special initial condition causing the contour tracking to begin in the south (down) direction whereas it will begin in the west direction afterwards. Segments like segment 26 will be used to store a failure-on-the-face condition (the common face of two successive pixels having different colors). Segments like segment 28 will be used to indicate color similarity with the line above. Segment 30 will be considered when starting up again the scrutiny for another contour.

The marking plane provides two advantages. On a structural point of view, the segments required for setting the marking data during the contour tracking will be created in advance. It is then simple to only modify their color used as a bit mask. Addition of segments is no longer necessary. The creation process of these segments is very linear and the initial creation penalty is absolutely negligible. On a conceptual point of view, an acceleration of the processing results from the aspect similarity that all the pixels in a same run have (same color, same type of border and same faces with the neighbors). Once a pixel beginning a segment is analyzed, the process jumps directly to the end of the segment. An acceleration also results from the already known information regarding the color similarity of the pixels above and below as the marking plane contains this information (using e.g. a flag). The performance increase can even lead to pre-compress any ordinary bitmap in order to get contouring speed benefit from the edge and distance prediction.

Table II below provides an example of an algorithm defining the steps for creating a progess marking plane.

TABLE II
Until all the lines have been explored {

Until the sum of the runs is equal to the image length {

Reading lines L1, L2, L3
Finding the smallest run (RLMin) between L1, L2 and L3
Storing a run of unitary length in n run line buffers
Subtracting 1 from the 3 runs extracted on each line
Storing RLMin if larger than 1 else storing 1
Subtracting RLMin from L1, L2, L3
Storing a run of unitary length in n run line buffers

-thus the smallest run is surrounded on each side
by a run having a unitary length

}
Exchanging the lines

-L3 becomes L2, L2 becomes L1 and the next line becomes
L3, i.e. positive line displacement

}

Color similarities between lines may be coded in the progress marking plane to accelerate the reading process. Instead of reading the color between two lines during the contour tracking and spending precious time for access to the run-length database, the required data is immediately available in the marking plane and the computation time during creation of the marking plane is almost nil since access to the runs is anyway necessary to create the marking plane. The position is based on the original runs and not on the new runs added for storing contour tracking data.

Referring back to FIG. 7, as depicted by block 12, a random pointing database in RL format may be created for facilitating navigation in the run-length coded image when performing the contour tracking. Access to an image matrix while tracking a contour can be considered as a random access. Since the matrix is too large to be kept in memory, it is kept in compressed format. But access to the color of a pixel becomes much more difficult since it is no longer possible to find the address of a pixel with a very simple computation based on the coordinates. The process may therefore be helped to avoid having to decompress all the runs of the page each time that a data is required. It is the role of the random pointing database to provide an acceleration of the access method to the data without decompressing them.

The database contains a set of pointers whose number depends on the covered area, and which contains the starting addresses of certain runs at specific positions. The method of access to the database is based on a determination X and Y of the coordinate request, which provides the address of the closest run, allowing then a fine search to locate the exact run starting the border under consideration. All the lines are described, and roughly one column over a hundred. Thus the computation of the entry point in the database is very simple. A first pass on the set of compressed data is made. At this occasion, the database is loaded with the addresses of the runs which straddle on each column of 100 pixels. The number 100 is relatively arbitrary (the higher, the smaller footprint for memory; the lower, the faster (more granular) access to a specific location) and may be different if desired or advantageous depending on the image size. Later, the navigation in the file of runs may then be almost random. It is no longer necessary to decompress a large quantity of data to find the exact requested coordinate. The access method may be optimized using cache memory systems and due to the fact that object contours are close enough between lines.

Table III below provides an example of an algorithm defining the steps for creating a random pointing database.

TABLE III

Number of columns NB_DBCol = Width / 100
For all the runs {

New line ? {

Create a new entry in the database
Set the length of the currently examined line to 0

}
for NB_DBCol {

Read a run
Add the run to line length
For each column crossed from the beginning to the end
of the run {

If run > 100, store each column entries with the
current address of the run table
Else, if first run, store column entry

}

}

}

As it can be seen, the above algorithm turns on the input runs and adds them until their sum exceeds the next hundred border. If the run exceeds a hundred, then the entry of the database will be loaded with the address of this run for each database entry associated with a column as long as the column of hundred where the run ends has not been reached.

As depicted by block 32, the next step of the conversion process consists of the contour tracking. Adjacent faces of pixels in the run-length coded image defining object contours are searched as a function of chromatic correlation between the adjacent faces as determined from the index data stored in the progress marking plane. The chromatic correlation may be an identical pixel color or pixel colors sufficiently similar with each other, or two distinct colors to be reduced as one color if desired. The faces of the pixels explored while searching are marked in associated ones of the segments of the progress marking plane, to prevent a face forming a part of an object contour found while searching from being considered again. Vector data representative of the faces of pixels defining the object contours found while searching may be generated during progression of the contour tracking.

During the contour tracking, a systematic exploration of the image, from top to bottom (or in another direction if desired) is achieved, pixel by pixel. In a general point of view, a pixel having a different color from the previous pixel, and on which the marking plane show no sign of past exploration, is searched. The marking plane is analyzed to determine if the pixel is already part of a contour previously explored (inside contour case). If it is the starting point of a contour to be explored, then the locations around this point will be explored. The exploration is achieved counterclockwise, beginning in the north (up) direction. If the color is not identical to the next color, then it is a failure and the exploration must continue. If the face is marked as already explored, then it is a failure because it is as retracing its steps. Else, it is a success. The coordinates of the point are stored and the data relating to the faces of the pixel are updated in the progress marking plane. The exploration continues down to the bottom of the page. During the search of a neighbor, the currently examined pixel is marked in the progress marking plane to avoid falsely considering it later as a neighbor of an internal run. This marking required for the contour tracking can be simply made directly on the RL compressed data of the progress marking plane as a segment is certain to exist for the considered location since it has been created in advance during the creation of the progress marking plane. In other words, the adjacent faces of the pixels defining object contours are searched, from each starting point, by tracking an object contour and by analyzing neighbors of the pixel defining the starting point in a counterclockwise direction in search of a neighbor having a same color. When the search is successful, the tracking is continued from the neighbor having a same color. The tracking is stopped and the contour is considered as finished when reaching the starting point. This can be determined for example when the marking plane shows that the only possible next direction to go is already marked as explored, or when a comparison of the coordinates under scrutiny with the coordinates of the starting point indicates that they are equal.

Referring to FIG. 4, in the contour tracking, the faces and corners of the pixels are considered. Filled arrows like arrow 34 represent a color success, i.e. the color of the pixel in the considered direction is identical to the color of the origin pixel. Thin arrows like arrow 36 represent a marking failure, i.e. the face followed in the considered direction has been marked as already explored in the progress marking plane. Empty arrows with a crosswise line like arrow 38 represent a color failure, i.e. the color of the pixel in the considered direction is different from the color of the origin pixel. The contour tracking will begin with the first corner 24 of the outer black contour. Contrary to the usual action, the exploration from the first corner 24 will always exceptionally begin in the south direction as it is useless to explore in the north direction, which is the normal direction which will be used thereafter. In the illustrated case, the contour point 42 will be immediately found. From this point 42, the first attempt to find a pixel having an identical color, i.e. in the north direction, result in failure since the face is marked as already explored.

The second attempt, i.e. in the west direction, results in success since the traversed face of the pixel has the same color. As a result, the scrutiny will move to the new point 44. From this point 44, the first and second attempts, in the north and west directions, result in failures. The third attempt, in the south direction, results in success and the tracking continues until the starting point of the contour tracking is reached, meaning that the object contour is finished for the detected objet in the image. The process then jumps to the next color transition in the image, forming a starting point for searching another contour in the image, and the above tracking steps are repeated. The determination of the next point to jumping is immediate by using the content of the progress marking plane which indicates the chromatic differences. The very important gain of the process resides in the immediate indication of the distance to jump before finding the next pixel of interest, which is directly and simply the value of the run in the marking plane. Normally, the starting points are defined by upper left corners of the pixels following a color transition between adjacent pixels in the run-length coded image.

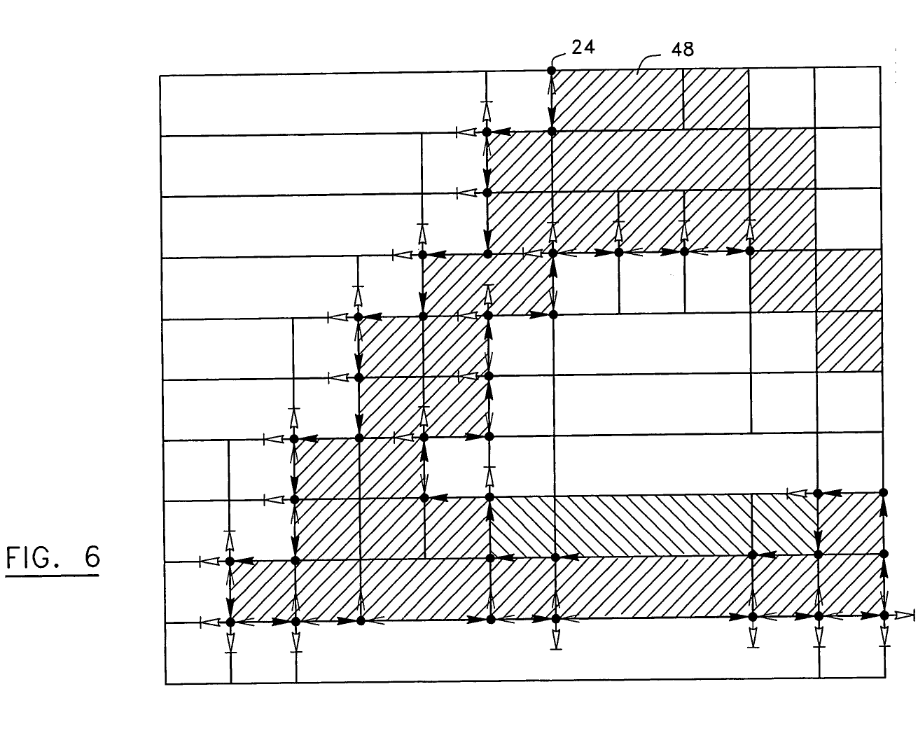

Referring to FIG. 6, there is shown a schematic diagram illustrating a run-length contour tracking. In the case where the lines of pixels have the same features, then the contour tracking directly jumps at the ends of the segments, as it is the case e.g. for the lines 46. The failures and successes during the contour tracking will be stored in the segments delineated in bold lines. For example, the failure in the west direction for the starting point will possibly be stored in the segment 48. The horizontal gains achieved using the above method are important, e.g. in the ratio of the compression rates (100:1). The vertical gains are not negligible too. A gain is due to the knowledge of the next pixel with the best color. A larger gain is achieved due to the time savings when searching a pixel having an identical color over or above by using the progress marking plane (compared to the browse penalty which is important for jumping from line to line in a compressed file). It is even advantageous to compress an ordinary raster file, even if of a reasonable size, before carrying out the above process.

For examining the data during the contour tracking, a function f(x,y) providing an approximate address in memory always before the position of the requested pixel is determined. Examining an image requires a function f(x,y)=color. On a W×H matrix (W representing the width and H representing the height), it is simply address=base address+(y×W+x). Table IV shows a possible algorithm to be used when working on a run-length data where indexation of positions close to each hundredth pixels has already been done.

TABLE IV
Computing g(x, y) = pm where pm represents an address in memory
on the line y (all the lines are indexed) of the closest run from x,
before the position x (only all the hundredth pixels are indexed)
Adding a run found from pm until sum > x to get closer to x
Taking the color at the address of the previous run (simple table
access, as if it were a matrix of pixels)

Examination of pixels using the algorithm of Table IV may be slower than examination of pixels in a matrix, but the amount of data involved in the compressed file is so smaller that it is advantageous. Also, it is easy to optimize the examination procedure with few coordinates and color caching mechanism. Reading the table of runs of the image is not completely random. The next position to be read is likely to be close to the current position. Thus, it can be kept in memory for eliminating the first step and eliminating 90% of the second step of the above algorithm.

Once the contour tracking is finished, a supplementary processing may be achieved e.g. for a transparent color if necessary. Transparent color is typically a flag indicating that the plane underneath is visible (typically the CT plane).

Referring back to FIG. 7, the vector data representing the contours may be generated in the form of a succession of elementary horizontal and vertical vectors of a single pixel length, stored in an internal vector database, representing moving directions along the faces of the pixels forming the object contours. Once a contour is found, the succession of elementary vectors—there is, in the above case, only four models, i.e. north (N), south (S), east (E) and west (W)—is analyzed as depicted by block 50 to detect vector similarities or pattern repetition and determine a more spatially economical vector concatenating the elementary vectors. For example, a 45 degree diagonal line is represented by a N-E-N-E-N-E or S-W-S-W-S-W series. A vertical line is represented by a N-N-N-N or S-S-S-S series depending on the direction of the run. Once a pattern is found, it is replaced, thus achieving a vector reduction. When no pattern appears, the elementary vectors are kept. It is less spatially economical but it is the safest solution. Complex pattern recognition may be performed at this stage, if desired, e.g. to detect circles, etc. A comparison of similar shapes may also be achieved, to reduce the number of elements which will be shown or drawn at the end. For example, two “A” in a page do not deserve two different storage spaces. Consequently, matching or highly similar shapes can be recognized and, instead of storing multiple instances of a same shape, only one (e.g. the first one) may be kept and the others may be replaced by references to the stored shape. Table V shows a simplified possible algorithm for analyzing the shapes.

TABLE V

Sorting the number of points
For each shape having a same number of points ± 1 (for a 1 pixel
tolerance) {

Verifying that the two shapes pass by the same relative
coordinates

}

As depicted by block 54, the internal vector database resulting from the contour tracking is converted into the desired image output format, e.g. in page-description language, portable document format or any other vector based format, and the vector image is thus produced by assembling the vector data accordingly.

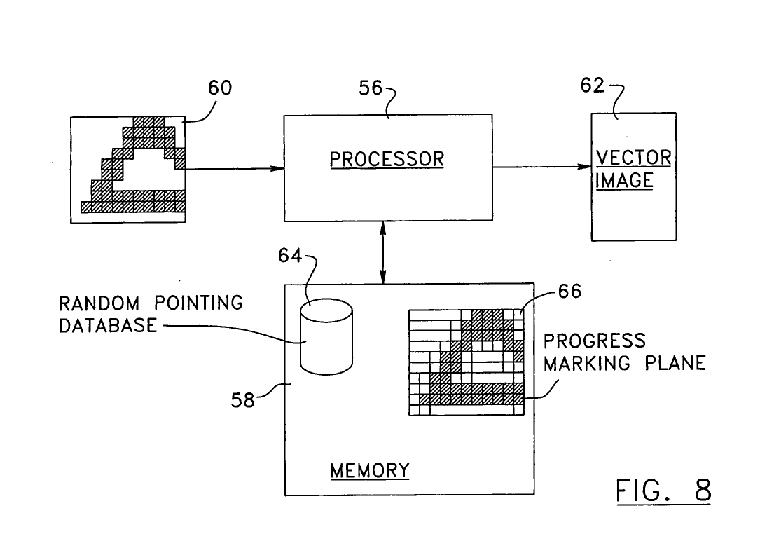

Referring to FIG. 8, the conversion process may be implemented through an apparatus provided with a processor 56 having an input for receiving the run-length coded image 60 and an output for producing the vector coded image 62. A memory 58 connected to the processor 56 is usable to store the random pointing database 64 and the progress marking plane 66 and all other data involved during the conversion process. The processor 56 and the memory 58 can be conveniently arranged to perform all the foregoing steps and operations of the process. The memory 58 may have recorded thereon statements and instructions for execution by a computer possibly containing the processor 56 to carry out the conversion process.

The conversion process may be embodied in a computer program product comprising a memory having computer readable code embodied therein, for execution by a processor. On a practical level, the computer program product may be embodied in software enabling a computer system to perform the operations, described above in detail, supplied on any one of a variety of media. An implementation of the approach and operations of the invention may be statements written in a programming language. Such programming language statements, when executed by a computer, cause the computer to act in accordance with the particular content of the statements. Furthermore, the software that enables a computer system to act in accordance with the invention may be provided in any number of forms including, but not limited to, original source code, assembly code, object code, machine language, compressed or encrypted versions of the foregoing, and any and all equivalents. The memory of the computer program product may take the form of a diskette, a tape, a compact disc, an integrated circuit, a ROM, a CD, a cartridge, a remote transmission via a communication circuit, or any other similar medium useable by computers. For example, to supply software for enabling a computer system to operate in accordance with the invention, the supplier might provide a diskette or might transmit the software in some form via satellite transmission, via a direct telephone link, or via the Internet. A carrier wave may embody a computer data signal representing sequences of statements and instructions which, when executed by a processor, cause the processor to perform the conversion process.

The memory 58 may be used for storing data for access by an application program being executed on a data processing system, comprising a data structure stored in the memory 58, the data structure including information resident in a database 66 in run-length format used by the application program and including segment data stored in the memory representing segments created as a function of run data in a run-length coded image 60 to be converted into a vector coded image 62 and usable to store index data indicative of color similarity between pixels in the run-length image and marking data indicative of pixels explored during conversion of the run-length coded image into a vector coded image.

The memory 58 may be used for storing data for access by an application program being executed on a data processing system, comprising a data structure stored in the memory 58, the data structure including information resident in a database 64 in run-length format used by the application program and including pointers indicating positions of a number of runs spaced apart in a run-length coded image 60 to be converted into a vector coded image 62 and usable for accelerated navigation in the run-length coded image 60 when searching object contours in the run-length coded image 60 based on pixel coordinates.

While embodiments of this invention have been illustrated in the accompanying drawings and described above, it will be evident to those skilled in the art that changes and modifications may be made therein without departing from the essence of this invention. For example, in the cases of a tiling based coded image, the principle of the process would consist in vectorizing the tiles separately, and to create a marking plane of the image which is a series of flags, one per line and per column, surrounding the tiles. On a comparative basis, it could be said that the first pixel of a run length series is a degenerated model of 1×1 tiles.

1. A raster-to-vector conversion process for converting a pattern descriptive coded image into a vector coded image, comprising:
creating a progress marking plane in pattern descriptive format with structural elements determined as a function of pattern data in the pattern descriptive coded image;
pre-loading the progress marking plane with index data stored in the structural elements, the index data being indicative of an aspect similarity between image-forming units in the pattern descriptive coded image;
searching adjacent faces of image-forming units in the pattern descriptive coded image defining object contours as a function of an aspect correlation between the adjacent faces as determined from the index data stored in the progress marking plane;
marking the faces of the image-forming units explored while searching in associated ones of the structural elements of the progress marking plane, to prevent a face forming a part of an object contour found while searching from being considered again;
generating vector data representative of the faces of image-forming units defining the object contours found while searching; and
producing the vector image by assembling the vector data.

2. The raster-to-vector conversion process according to claim 1, wherein the image-forming units comprise image pixels or tiles.

3. The raster-to-vector conversion process according to claim 1, wherein the aspect similarity comprises color similarity.

4. The raster-to-vector conversion process according to claim 1, wherein the pattern descriptive coded image comprises a run-length coded image, the pattern descriptive format comprises run-length format, and the structural elements comprise segments.

5. The raster-to-vector conversion process according to claim 1, wherein the aspect correlation comprises chromatic correlation.

6. The raster-to-vector conversion process according to claim 1, comprising jumping to starting points for searching in the pattern descriptive coded image using aspect (color) transition information between adjacent image forming units (pixels) as provided by the structural elements (segments) in the progress marking plane.

7. The raster-to-vector conversion process according to claim 1, comprising performing a vector reduction on the vector data by analysis of vector similarities and concatenation of the vector data as a function of the vector similarities prior to assembling the vector data.

8. The raster-to-vector conversion process according to claim 1, wherein the vector data are assembled in a predetermined image output format.

9. The raster-to-vector conversion process according to claim 8, wherein the image output format comprises one of a page-description language and portable document format.

10. The raster-to-vector conversion process according to claim 1, comprising:
creating a random pointer database in pattern descriptive format (run-length);
storing pointers indicating positions of a number of patterns spaced apart in the pattern descriptive coded image; and
using the pointers for navigation in the pattern descriptive coded image when searching.

11. The raster-to-vector conversion process according to claim 1, comprising:
analyzing the aspect similarity between the image-forming units in the pattern description coded image as a function of neighboring image-forming unit information; and
creating new structural elements of unitary pattern length before and after each existing structural element transition in the pattern descriptive coded image, the structural elements created in the progress marking plane comprising the new structural elements and structural elements derived from the pattern data reduced as a result of the new structural elements created.

12. The raster-to-vector conversion process according to claim 11, wherein the index data comprise data indicating a nature of each image-forming unit in the pattern descriptive coded image with respect to the image-forming units above, below, left and right.

13. The raster-to-vector conversion process according to claim 1, comprising:
searching the object contours having substantially matching shapes; and
replacing the vector data of subsequent ones of the object contours having substantially matching shapes by references to a first one of the object contours having the substantially matching shapes.

14. The raster-to-vector conversion process according to claim 6, wherein the starting points are defined by upper left corners of the image-forming units following a color transition between adjacent image-forming units in the pattern descriptive coded image.

15. The raster-to-vector conversion process according to claim 14, wherein the adjacent faces of the image-forming units defining object contours are searched, from each starting point, by:
tracking an object contour by analyzing neighbors of the image-forming unit defining the starting point in a counterclockwise direction in search of a neighbor having a same aspect;
continuing, when the search is successful, the tracking from the neighbor having a same aspect; and
stopping the tracking when reaching the starting point, the object contour being thereby finished.

16. The raster-to-vector conversion process according to claim 1, wherein the vector data is generated from image-forming unit length elementary vectors representing moving directions along the faces of the image-forming units forming the object contours.

17. A raster-to-vector conversion apparatus for converting a pattern descriptive coded image into a vector coded image, comprising:
means for creating a progress marking plane in pattern descriptive format with structural elements determined as a function of pattern data in the pattern descriptive coded image;
means for pre-loading the progress marking plane with index data stored in the structural elements, the index data being indicative of an aspect similarity between image-forming units in the pattern descriptive coded image;
means for searching adjacent faces of image-forming units in the pattern descriptive coded image defining object contours as a function of an aspect correlation between the adjacent faces as determined from the index data stored in the progress marking plane;
means for marking the faces of the image-forming units explored while searching in associated ones of the structural elements of the progress marking plane, to prevent a face forming a part of an object contour found while searching from being considered again;
means for generating vector data representative of the faces of image-forming units defining the object contours found while searching; and
means for producing the vector image by assembling the vector data.

18. The raster-to-vector conversion apparatus according to claim 17, comprising means for jumping to starting points for searching in the pattern descriptive coded image using aspect transition information between adjacent image-forming units as provided by the structural elements in the progress marking plane.

19. The raster-to-vector conversion apparatus according to claim 17, comprising means for performing a vector reduction on the vector data by analysis of vector similarities and concatenation of the vector data as a function of the vector similarities prior to assembling the vector data.

20. The raster-to-vector conversion apparatus according to claim 17, comprising:
means for creating a random pointer database in pattern descriptive format;
means for storing pointers indicating positions of a number of patterns spaced apart in the pattern descriptive coded image; and
means for using the pointers for navigation in the pattern descriptive coded image when searching.

21. The raster-to-vector conversion apparatus according to claim 17, comprising:
means for analyzing the aspect similarity between the image-forming units in the pattern descriptive coded image as a function of neighboring image-forming unit information; and
means for creating new structural elements of unitary length before and after each existing structural element transition in the pattern descriptive coded image, the structural elements created in the progress marking plane comprising the new structural elements and structural elements derived from the pattern data reduced as a result of the new structural elements created.

22. The raster-to-vector conversion apparatus according to claim 17, comprising:
means for searching the object contours having substantially matching shapes; and
means for replacing the vector data of subsequent ones of the object contours having substantially matching shapes by references to a first one of the object contours having the substantially matching shapes.

23. A computer readable memory having recorded thereon statements and instructions for execution by a computer to carry out the process of claim 1.

24. A computer program product, comprising a memory having computer readable code embodied therein, for execution by a processor, for converting a pattern descriptive coded image into a vector coded image, said code comprising:
code means for creating a progress marking plane in pattern descriptive format with structural elements determined as a function of pattern data in the pattern descriptive coded image;
code means for pre-loading the progress marking plane with index data stored in the structural elements, the index data being indicative of an aspect similarity between image-forming units in the pattern descriptive coded image;
code means for searching adjacent faces of image-forming units in the pattern descriptive coded image defining object contours as a function of an aspect correlation between the adjacent faces as determined from the index data stored in the progress marking plane;
code means for marking the faces of the image-forming units explored while searching in associated ones of the structural elements of the progress marking plane, to prevent a face forming a part of an object contour found while searching from being considered again;
code means for generating vector data representative of the faces of image-forming units defining the object contours found while searching; and
code means for producing the vector image by assembling the vector data.

25. A carrier wave embodying a computer data signal representing sequences of statements and instructions which, when executed by a processor, cause the processor to convert a pattern descriptive coded image into a vector coded image, the statements and instructions comprising:
creating a progress marking plane in pattern descriptive format with structural elements determined as a function of pattern data in the pattern descriptive coded image;
pre-loading the progress marking plane with index data stored in the structural elements, the index data being indicative of an aspect similarity between image-forming units in the pattern descriptive coded image;
searching adjacent faces of image-forming units in the pattern descriptive coded image defining object contours as a function of aspect correlation between the adjacent faces as determined from the index data stored in the progress marking plane;
marking the faces of the image-forming units explored while searching in associated ones of the structural elements of the progress marking plane, to prevent a face forming a part of an object contour found while searching from being considered again;
generating vector data representative of the faces of image-forming units defining the object contours found while searching; and
producing the vector image by assembling the vector data.

26. A memory for storing data for access by an application program being executed on a data processing system, comprising a data structure stored in said memory, said data structure including information resident in a database in pattern descriptive format used by said application program and including structural element data stored in said memory representing structural elements created as a function of pattern data in a pattern descriptive coded image to be converted into a vector coded image and usable to store index data indicative of an aspect similarity between image-forming units in the pattern descriptive coded image and marking data indicative of image-forming units explored during conversion of the pattern descriptive coded image into a vector coded image.

27. A memory for storing data for access by an application program being executed on a data processing system, comprising a data structure stored in said memory, said data structure including information resident in a database in pattern descriptive format used by said application program and including pointers indicating positions of a number of patterns spaced apart in a pattern descriptive coded image to be converted into a vector coded image and usable for accelerated navigation in the pattern descriptive coded image when searching object contours in the pattern descriptive coded image based on image-forming unit coordinates.
